(19) United States
(12) Patent Application Publication
(10) Pub. No.: US 2022/0112914 A1
(43) Pub. Date: Apr. 14, 2022

(54) Fastening Unit

(71) Applicant: PROFIL Verbindungstechnik GmbH & Co. KG, Friedrichsdorf (DE)

(72) Inventors: Oliver Diehl, Usingen (DE); Austin Gordon Scott Hefner, Royal Oak, MI (US); Tobias Jene, Friedrichsdorf (DE)

(21) Appl. No.: 17/425,143

(22) PCT Filed: Jun. 24, 2020
(86) PCT No.: PCT/EP2020/067729

§ 371 Date: Jul. 22, 2021

(30) Foreign Application Priority Data
Jun. 25, 2019 (DE) 10 2019 117 086.9

(51) Int. Cl. F16B 19/10; F16B 19/08

(52) U.S. Cl. CPC F16B 19/1063; F16B 19/086

(57) ABSTRACT

The present invention relates to a fastening unit for fastening to a workpiece, said fastening unit comprising a rivet element and a reshaping element coupled to the rivet element and movable relative thereto, wherein the rivet element has a rivet section and the reshaping element has a reshaping section and a support section, which is arranged at a region of the reshaping element remote from the reshaping section, for axially supporting the fastening unit at an abutment. The rivet section and the reshaping section are designed such that, on an axial relative movement between the rivet element and the reshaping element that is produced by an introduction movement, the rivet section cooperates with the reshaping section and can be reshaped by it in a radial direction.

The invention relates to a fastening unit for fastening to a workpiece.

In many areas, in particular in the automotive sector, it is necessary to connect the most varied types of components to one another. In many cases, it is, however, not possible to establish a direct connection between the components. For example, they cannot be easily welded to one another due to the respective material properties. Direct screw connections also cannot always be realized since the present geometric conditions do not allow it or only allow it with a considerable effort. With comparatively thin components, such as sheet metal parts, direct screw connections are usually ruled out anyway.

To circumvent the problems described above, a fastening unit is first attached to the component or the workpiece, for example by a riveting process. Such a fastening unit in turn has a functional section that enables a connection to other components or workpieces.

Riveting processes comprise the reshaping of a section of the fastening unit such that an undercut is produced by which the element is reliably connected to the workpiece. A die is usually required for the reshaping of the so-called rivet section of the unit. In the fastening process, the rivet section is guided through a prefabricated hole in the workpiece or is guided by punching through the workpiece and is pressed against the die on the rear side of the workpiece (for example, by a setting device), whereby said rivet section is deformed due to the shaping of the die in order to form the undercut described.

However, due to the shape of the workpiece, it is already frequently difficult or impossible to bring a die into a position suitable for the fastening process.

It is therefore an object of the present invention to provide a fastening unit that can also be efficiently and reliably fastened to the workpiece in such cases.

This object is satisfied by a fastening unit having the features of claim 1.

In accordance with the invention, the fastening unit has a rivet element and a reshaping element that is coupled to the rivet element—preferably captively coupled—and that is movable relative thereto. The rivet element has a rivet section and the reshaping element has a reshaping section and a support section, which is arranged at a region of the reshaping element remote from the reshaping section, for axially supporting the fastening unit at an abutment. The rivet section and the reshaping section are designed such that, on an axial relative movement between the rivet element and the reshaping element that is produced by an introduction movement, the rivet section cooperates with the reshaping section and can be reshaped by it in a radial direction.

The relative movement of the elements is a movement toward one another. It is produced when the abutment slows down an introduction movement of the reshaping element while the rivet element still moves in the introduction direction.

The support section and the reshaping section are in particular arranged at oppositely disposed ends of the reshaping element and are spaced apart from one another.

The reshaping section thus acts as a reshaping die. Due to the coupling, which is in particular captively designed, of the rivet element and the reshaping element, the fastening unit ultimately provides its own die. The user can therefore be supplied with a prefabricated component which he can then use without pre-assembly. The provision of a separate, wear-prone die is no longer necessary. Only one abutment has to be present.

The rivet element and the reshaping element can be separate components. However, it is also conceivable, for example, that the two elements are connected to one another in one piece and have a desired breaking point or a desired bending point that allows a relative movement of the two elements on an exceeding of a specific force. The two elements are in particular no longer connected to one another in one piece after the completion of the fastening process.

The rivet element and the reshaping element can be coupled to one another by means of the rivet section and the reshaping section. The reshaping section can for this purpose have a coupling section. The reshaping section is in particular sectionally introduced, preferably plugged in or pressed in, into a recess of the rivet section. The coupling section can diverge away from the rivet section in an axial direction, e.g. it can be sectionally conical.

The rivet section and/or the reshaping section can be designed in ring shape, in particular in circular ring shape. A rotationally symmetrical design of said sections and/or further sections of the rivet element and/or of the reshaping element is advantageous in many cases since it enables a simple manufacture and/or assembly of the fastening unit. However, a symmetrical design, in particular a rotationally symmetrical design, can be deviated from for certain applications.

The reshaping element can comprise an outer contour that does not project over an outer contour of the rivet section in the radial direction in order to facilitate the introduction of the fastening unit into the workpiece.

The reshaping section can have a reshaping surface that diverges away from the rivet section in an axial direction, in particular wherein the reshaping surface is curved in order to convert the mentioned relative movement of the two elements into a reshaping of the rivet section. The reshaping surface can adjoin the coupling section in the axial direction, viewed from the rivet element. A transition between the reshaping surface and the coupling section can be continuous or can have an edge.

In accordance with a compact embodiment of the fastening unit, the rivet element and the reshaping element are coaxially arranged.

In a region of the rivet element remote from the rivet section, the rivet element can have a flange section configured for contact with the workpiece and/or a section widened radially relative to the rivet section. This measure increases the reliability of the fastening of the unit to the workpiece. The unit can then engage around the workpiece at both sides by the rear grip produced by reshaping and by the flange section or the widened section.

The fastening unit can be provided for the use at a pre-punched workpiece. It can, however, also be self-punching. The reshaping element in particular comprises a punching section at an end remote from the reshaping section.

In accordance with an embodiment of the unit, the support section has a support surface that comprises an elevated portion and/or a cut-out. The cut-out can (partly) receive the punched-out slug in a self-punching unit. For example, the cut-out is defined by a piercing edge that rises from the support surface.

The rivet element and/or the reshaping element can have a throughgoing axial opening. The elements can be formed like a sleeve. They can at least sectionally be provided with an internal thread in order thus to functionally act as a nut element. The reshaping element—whether provided with a blind bore or with a throughgoing bore—preferably has an internal thread. In some embodiments, the reshaping element is designed as considerably more solid than the rivet element, in particular when the reshaping element acts as a stabilizing element and/or as a spacer, as will be explained further in the following. It can therefore better absorb forces that are introduced by the thread.

Provision can also be made that the rivet element is closed in the axial direction. It can have a cover-like design. In this embodiment, the rivet element, for example, closes a throughgoing axial opening of the reshaping element.

The rivet element and/or the reshaping element can have a functional section having an internal thread or an external thread. The fastening unit can have the functionality of a nut or of a (threaded) bolt. Embodiments with a combination of these functionalities are also possible.

The rivet section and/or the reshaping section and/or the support section in particular has/have at least one feature providing security against rotation, in particular at least one rib and/or groove extending at least sectionally in the axial direction or the radial direction. An outer contour of said sections can also bring about a security against rotation, namely if it deviates from a circular basic shape. The basic shape can, for example, be oval or a triangle, a square, or a polygon. The corners and edges of these basic shapes are preferably rounded.

The present invention further relates to a component assembly comprising a workpiece, in particular a sheet metal part, and a fastening unit in accordance with at least one of the embodiments described above fastened to the workpiece. A reshaped section of the rivet section in this respect at least sectionally engages behind the workpiece at a side remote from an introduction side. The introduction side is the side of the workpiece from which the fastening unit is introduced into the workpiece. The workpiece can be a closed or a partly open hollow section.

In accordance with an embodiment, the reshaping element is supported in the axial direction at the workpiece, in particular at an end of the reshaping element remote from the reshaping section.

The reshaping element can extend through a hollow space of the workpiece, which also has a positive effect on the mechanical stability of the workpiece.

In accordance with an embodiment of the fastening unit, an axial extent of the rivet element is smaller than that of the reshaping element, in particular if the latter is to act as a spacer or as a stabilizing element (see above). The axial extent of the reshaping element can be adapted to the geometry of the hollow section workpiece to be stabilized or of the hollow space to be spanned. The rivet element can be a standard element whose axial extent is selected independently of the geometry of the workpiece described above. For example, the axial extent of the reshaping element is greater than twice, 3 times, 4 times, or 5 times the axial extent of the rivet element in a non-deformed state (that is prior to fastening to the unit at the workpiece).

The workpiece can have a prefabricated opening for receiving the fastening unit. However, it is also possible to obtain the component assembly by the use of a self-punching fastening unit. A slug punched out of the workpiece by the fastening unit can be clamped between the fastening unit and the workpiece so that it cannot wander around in a disturbing manner.

In accordance with an embodiment of the component assembly, the abutment is formed at the workpiece.

The invention further relates to a method of manufacturing a component assembly in accordance with any one of the embodiments described above comprising the steps:
providing a pre-punched or non-pre-punched workpiece;
providing a fastening unit in accordance with at least one of the embodiments described above; and
introducing the fastening unit into the workpiece such that the support section cooperates with an abutment to bring about a relative movement between the rivet element and the reshaping element and thus a reshaping of the rivet section in a radial direction.

The relative movement of the elements is a movement of the elements toward one another.

In accordance with an embodiment of the method, the fastening unit is introduced into the workpiece and is fixed thereto by means of a single-step axial introduction movement. Therefore, no mutually opposed movements are required to effect the introduction and the fixing of the unit. These two processes can therefore take place in the course of a single movement that can be continuous or that can comprise an application of force and/or a speed of movement that is variable in time, which considerably simplifies the fastening process.

The introduction of the fastening unit into the workpiece and the fixing of the fastening unit to the workpiece can be produced by movement components of the same direction, in particular wherein the movement components merge into one another.

The present invention will be described in the following purely by way of example with reference to advantageous embodiments and to the enclosed drawings. There are shown:

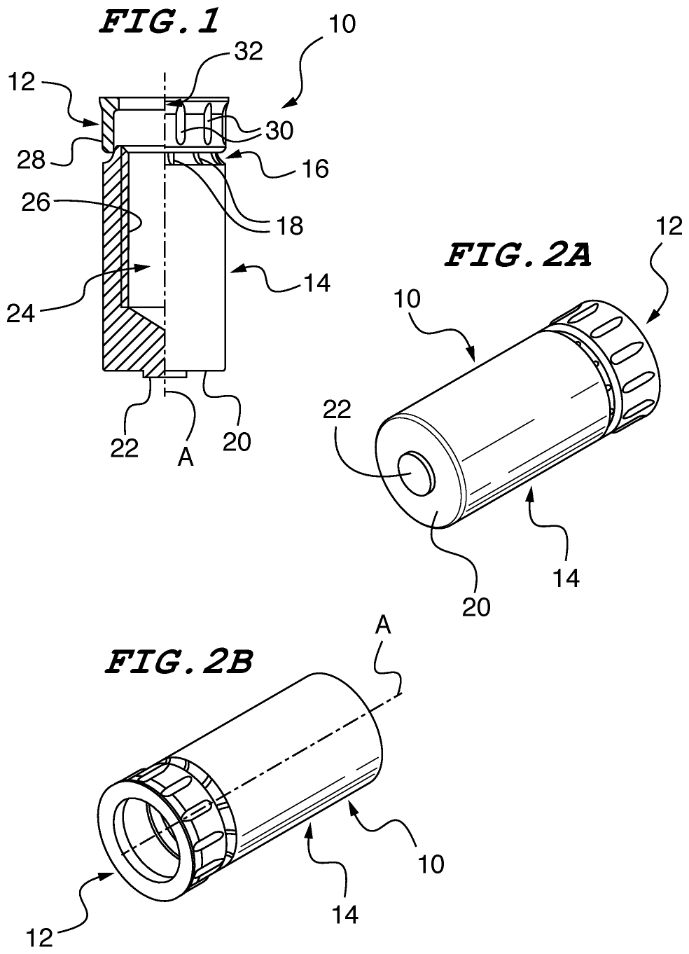

FIG. 1 an embodiment of the fastening unit in accordance with the invention;

FIGS. 2A, 2B the fastening unit in accordance with FIG. 1 in different perspective views;

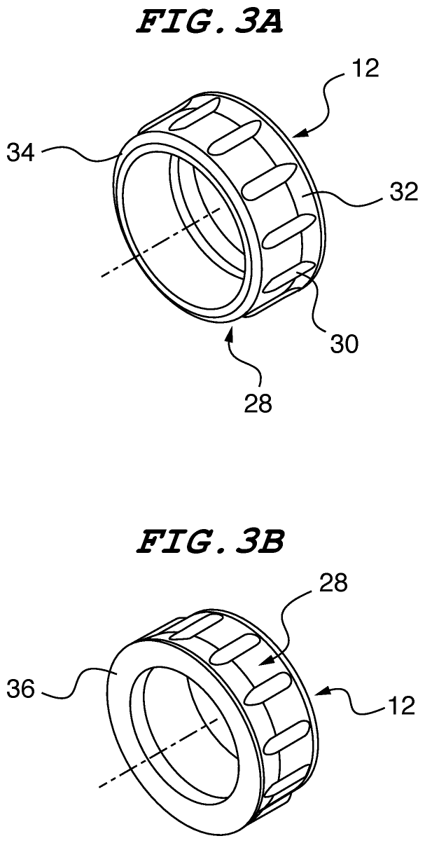

FIGS. 3A, 3B the rivet element of the fastening unit in accordance with FIG. 1 in different perspective views;

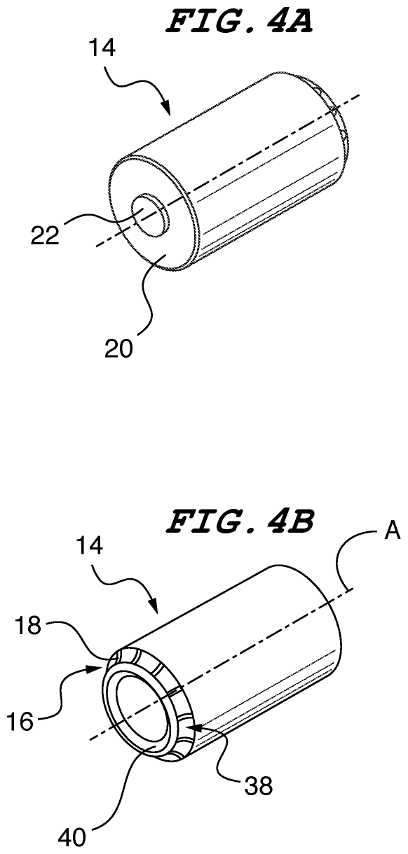

FIGS. 4A, 4B the reshaping element of the fastening unit in accordance with FIG. 1 in different perspective views;

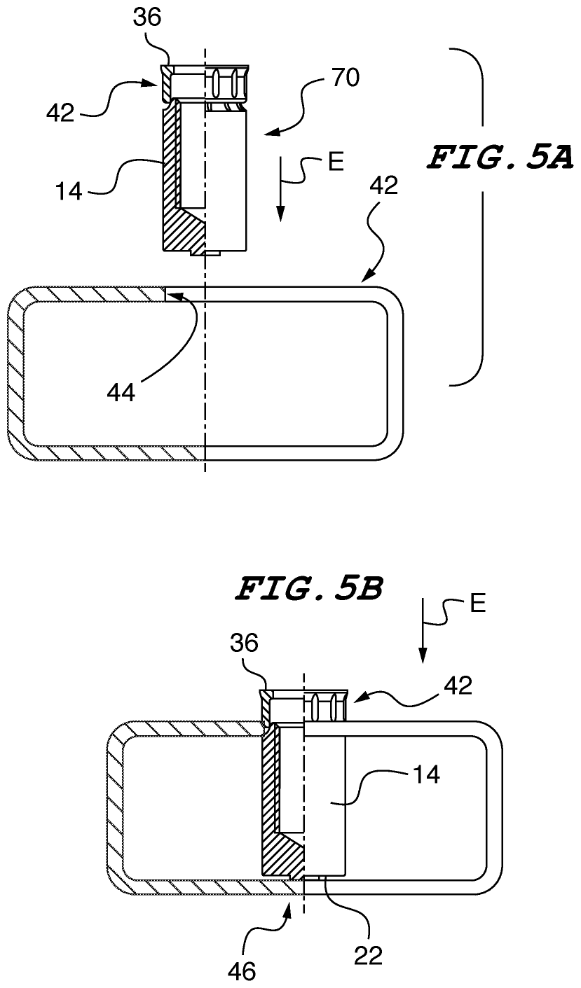

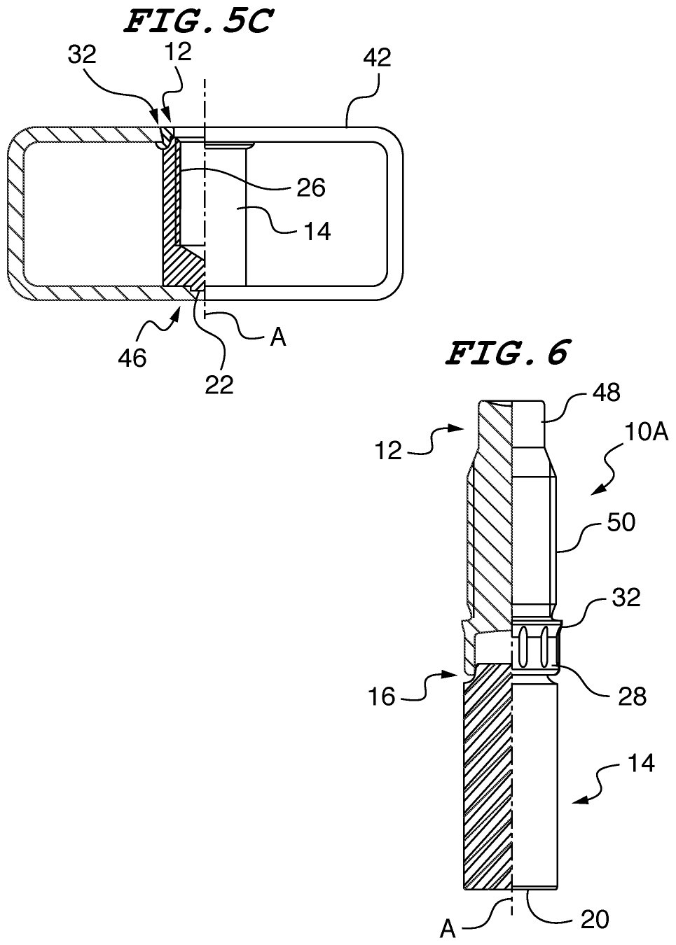

FIGS. 5A to 5C the fastening of the fastening unit in accordance with FIG. 1 to a workpiece;

FIG. 6 a second embodiment of the fastening unit in accordance with the invention;

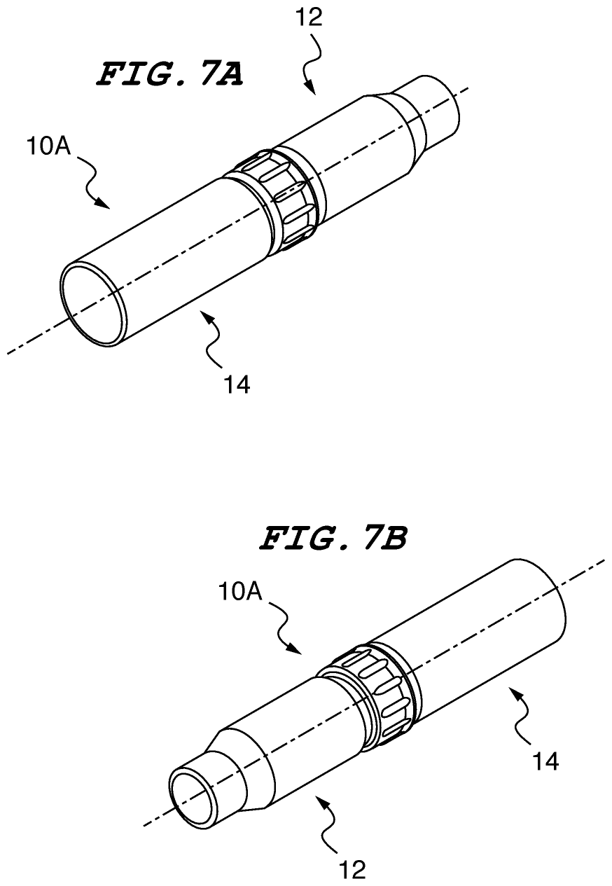

FIGS. 7A, 7B the fastening unit in accordance with FIG. 6 in different perspective views;

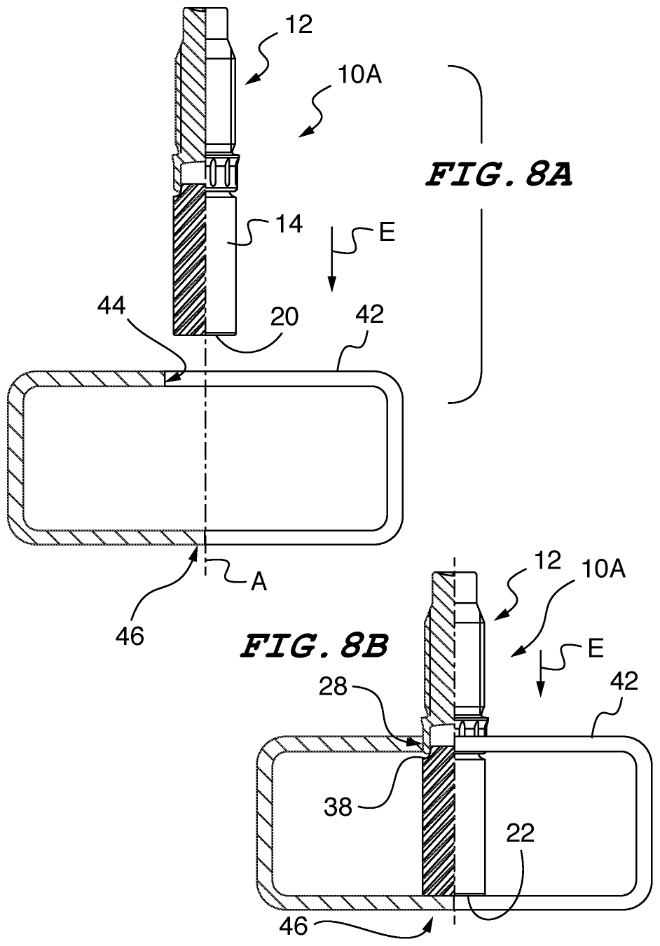

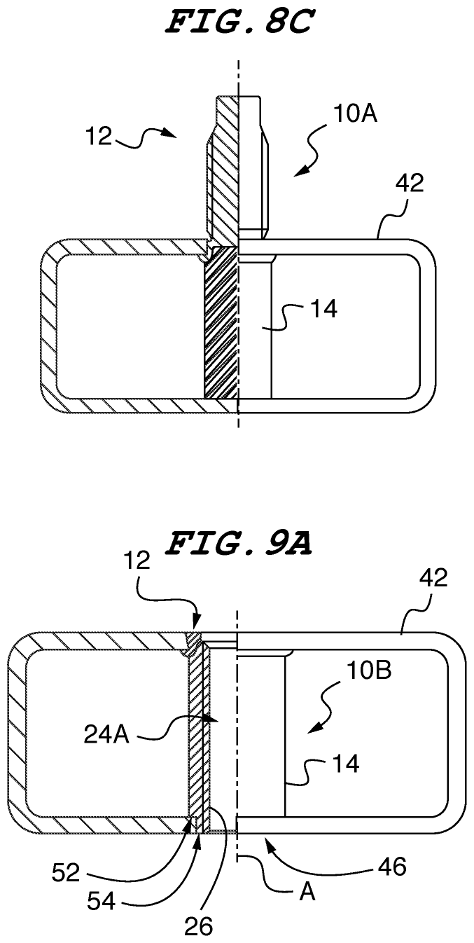

FIGS. 8A to 8C the fastening of the fastening unit in accordance with FIG. 6 to a workpiece;

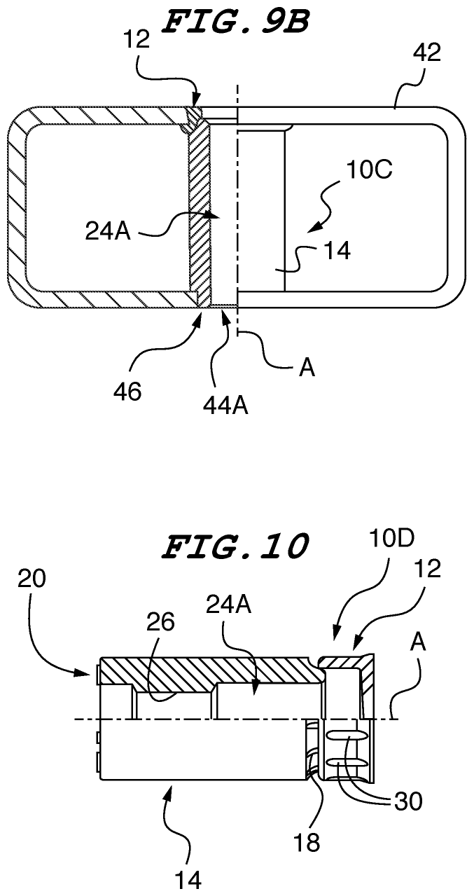

FIGS. 9A, 9B further embodiments of the fastening unit in accordance with the invention;

FIG. 10 a further embodiment of the fastening unit in accordance with the invention;

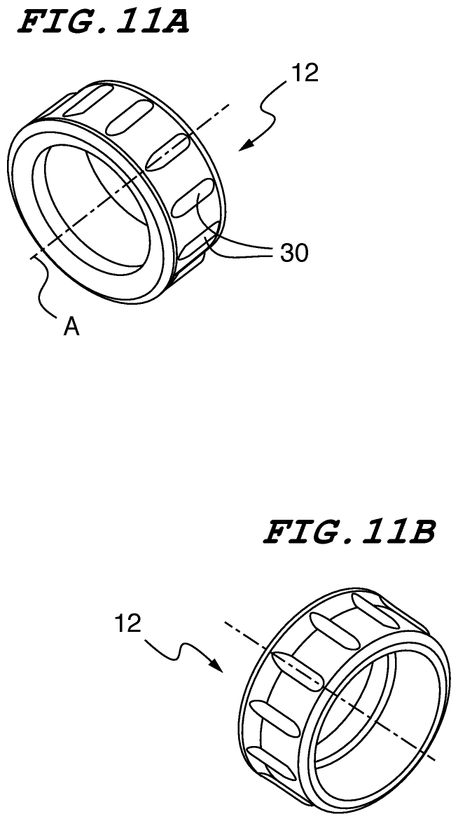

FIGS. 11A, 11B the rivet element of the fastening unit in accordance with FIG. 10 in different perspective views;

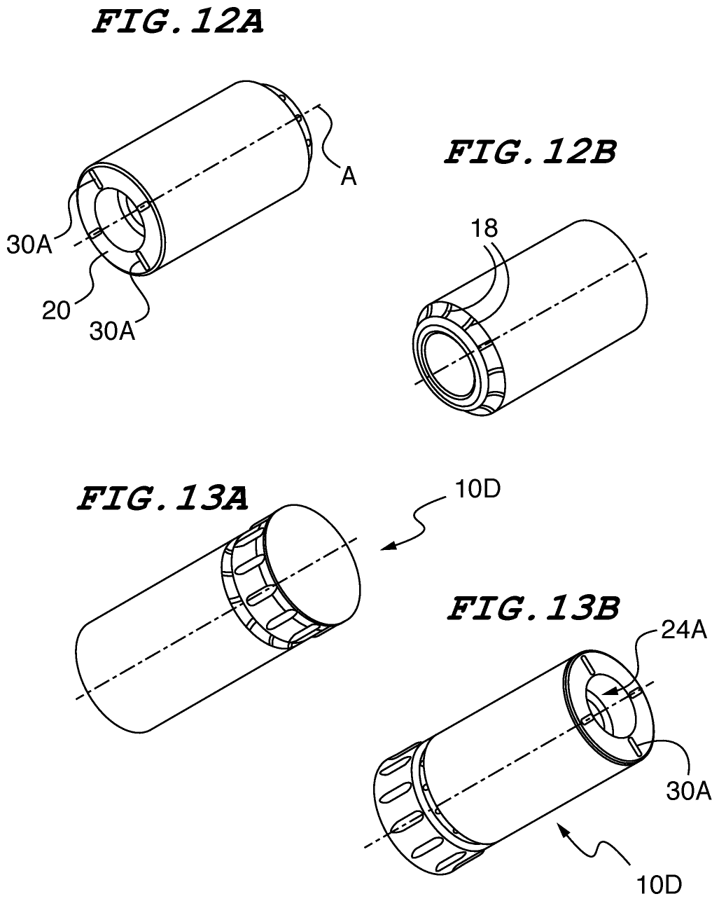

FIGS. 12A, 12B the reshaping element of the fastening unit in accordance with FIG. 10 in different perspective views;

FIGS. 13A, 13B the fastening unit in accordance with FIG. 10 in different perspective views; and

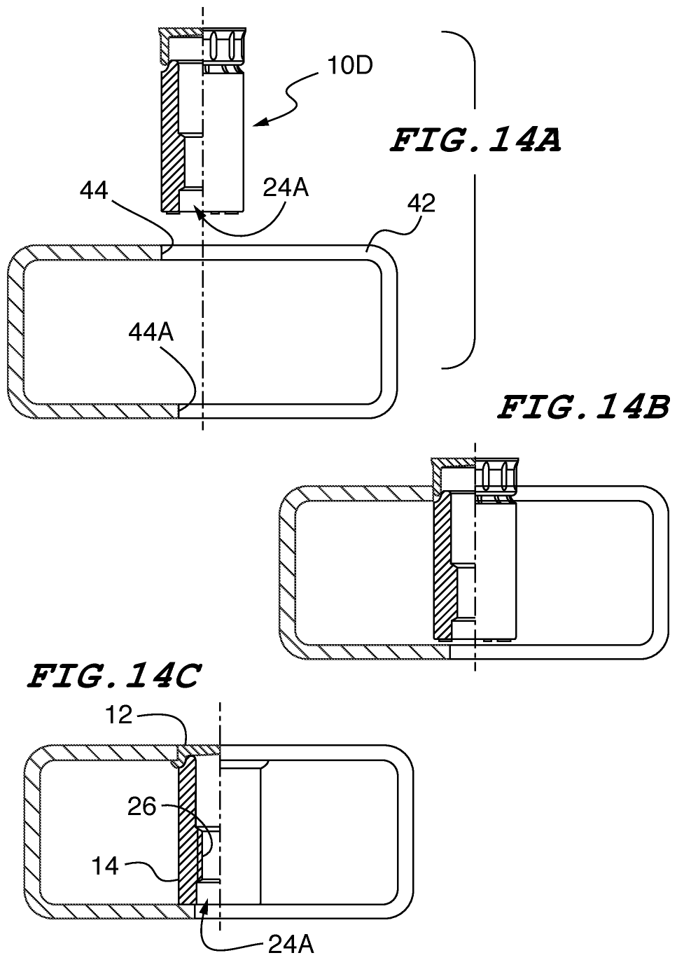

FIGS. 14A to 14C the fastening of the fastening unit in accordance with FIG. 10 to a workpiece.

FIG. 1 shows a fastening unit 10 in a sectional view (left of a longitudinal axis A) or in a side view (right of the axis A). The fastening unit 10 comprises a rivet element 12 and a reshaping element 14 that are plugged into or pressed into one another to couple the two elements 12, 14 to one another.

The reshaping element 14 has a reshaping section 16 that diverges away from the rivet element 12 and that sectionally has a curvature in the present example. The section 16 can also have a conical shape. It is provided with ribs 18 providing security against rotation that extend in the axial direction and that are arranged distributed in the peripheral direction. At the end remote from the reshaping section 16, the reshaping element 14 has a support surface 20 from which an elevated portion 22 extends. The element 14 further has a central bore 24 having an internal thread 26.

The reshaping section 16 is sectionally pressed into a ring-shaped rivet section 28 of the rivet element 12 so that the elements 12, 14 are captively coupled to one another. The rivet section 28 is provided at its outer side with ribs 30 providing security against rotation that extend in the axial direction and that are arranged distributed in the peripheral direction. At the end remote from the rivet section 28, the rivet element 12 has a collar 32 that diverges away from the rivet section 28, that is conical, but that can also be curved. Additionally or alternatively, a flange section can be provided here that has a contact surface that can be brought into contact with the workpiece.

The elements 12, 14 are substantially rotationally symmetrical. However, in certain applications it may also be advantageous to select a substantially oval cross-sectional shape—viewed in a plane perpendicular to the axis A. Other cross-sectional shapes, such as square, rectangular, or polygonal shapes, can likewise be used. Corners and/or edges of the basic shapes can be rounded.

In FIGS. 2A and 2B, the fastening unit 10 is shown in different perspective views, which illustrates its compact design. In simplified terms, the rivet element 12 is formed like a sleeve. It is sufficiently fixedly plugged onto an end of the reshaping element 14 of substantially cylindrically design to be able to be moved as a pre-assembled unit 10 to a workpiece to which it is to be fastened.

FIGS. 3A and 3B show the rivet element 12 in different perspective views so that its sleeve-like character can be recognized more clearly. The rivet section 28 is substantially a hollow cylindrical section that is chamfered at the outer side at the end remote from the collar 32 (chamfer 34). The ribs 30 providing security against rotation do not extend completely up to the chamfer 34, but do project into the collar 32. At a side remote from the reshaping element 14 in a pre-assembled state, the element 12 has a ring-shaped pressure surface 36 at which a setting device engages by which the unit 10 is fastened to a workpiece, as will be explained further in the following.

FIGS. 4A and 4B show the reshaping element 14 in different perspective views. It must be mentioned with respect to FIG. 4A that the round, flat elevated portion 22 can also have a regular or irregular shape that converges away from the surface 20. A shape that deviates from a rotational symmetry can—as will become clear in the following—serve as a feature providing security against rotation. The elevated portion 22 can also be provided with axial ribs if necessary.

The reshaping section 16 can be easily recognized in FIG. 4B. It is divided into a reshaping surface 38, which is provided with the ribs 18 providing security against rotation, and a coupling section 40 that is free of such ribs in the present example. In a pre-assembled state of the fastening unit 10, the coupling section 40 is inserted into the rivet section 28, in particular inserted so far that the rivet section 28 contacts the ribs 18. The transition between the coupling section 40, which can be conical or curved to facilitate the plugging on of the rivet element 12, and the reshaping surface 38 is preferably continuous. However, an edge can also be provided in the transition region.

With reference to FIGS. 5A to 5C, it will be explained in the following how the unit 10 is fastened to a workpiece 42, here by way of example a hollow section composed of metal (sheet metal part). A sectional view can be seen left of the axis A; a side view is shown to the right thereof. A conventional fastening element cannot be used here since no die can be placed in the interior of the workpiece.

The workpiece 42 is pre-punched, i.e. it already has a hole 44 at the beginning of the fastening process through which the unit 10 can be introduced into the workpiece 42. The unit 10 can generally also be self-punching.

The fastening of the unit 10 to the workpiece 42 takes place by a setting device, not shown, that acts on the pressure surface 36 and thus moves the unit 10 in the introduction direction E.

In FIG. 5B, a state is shown in which the unit 10 has already penetrated so deeply into the workpiece 42 that the elevated portion 22 contacts an inner side of a section 46 of the workpiece 42 disposed opposite the hole 44. From this point in time onward, the corresponding workpiece section 46, which is in turn supported on a support surface that is not shown, acts as an abutment that counteracts the introduction movement in the direction E. However, since the setting device continues to act on the pressure surface 36, the rivet element 12 is now strongly pressed against the reshaping element 14 in the axial direction so that the rivet section 28 runs onto the reshaping surface 38 and is bent over radially outwardly due to the shape of said reshaping surface 38, as shown in FIG. 5C. The rivet section 28 then partly engages behind a region of the workpiece 42 around the hole 44.

The elevated portion 22 was pressed into the workpiece section 46 in the end state shown in FIG. 5C. The reshaping element 14 now extends between oppositely disposed inner sides of the workpiece 42 and provides it with an additional mechanical stability. It can also act as a kind of spacer. The element 14 remains in the workpiece 42 and also secures the connection between the rivet element 12 and the workpiece 42. This securing would generally not be absolutely necessary since the workpiece 42 is reliably clamped between the collar 32 and the engaging-behind, reshaped section of the rivet section 28.

The ribs 30 secure the element 12 against a rotation relative to the workpiece 42 since they have dug into the wall of the hole 44. Ribs 18 provide a security against rotation between the elements 12 and 14.

It is understood that the fastening of the unit 10 can also be carried out without an elevated portion 22. It must further be pointed out that the unit 10 can also be used for other workpieces than hollow sections. The support surface 20 (with or without an elevated portion 22) can then be supported at a separate contact surface in the fastening process. Under certain circumstances, it is also conceivable that the reshaping element 14 is removed and—if desired—reused after the completion of the fastening process.

Once the unit 10 has been reliably fastened to the workpiece 42, the internal thread 26 can be used for fastening further components to the workpiece 42.

An essential aspect of the unit 10 is that, as a pre-assembled component, it comprises both a rivet element and the die required for its fastening. This enables the fastening of the rivet element in particular in situations in which the die cannot be moved into the required position. In the above-described embodiment, the reshaping element 14 acting as a die simultaneously serves as a fastening element in the actual sense since it has the internal thread 26. It is generally also possible to provide the rivet element 12 with an internal thread, for example, in a region of the collar 32 that then preferably has a larger axial extent.

FIG. 6 shows a fastening unit 10a that corresponds to the fastening unit 10 described above with respect to the design of the sections 16 (with the coupling section 40 and the reshaping surface 38) and 28 and with respect to the manner of the fastening. However, the rivet element 12 does not have a throughgoing opening, but is rather provided with a bolt section 48, which bears an external thread 48, at the side of the collar 32 remote from the rivet section 28. The reshaping element 14 is designed as solid since it does not have to provide an actual fastening function. However, it can likewise have a blind bore or a passage bore for the purposes of the weight reduction. Its support surface 20 furthermore does not have an elevated portion 22.

FIGS. 7A and 7B show perspective views of the unit 10a.

FIGS. 8A to 8C show the fastening of the unit 10a to the workpiece 42. It can be seen that the process takes place analogously to that process which was described with reference to FIGS. 5A to 5C. When the support surface 20 abuts the workpiece section 46, the movement of the element 14 substantially stops while the element 12 continues to be moved in the introduction direction E by the setting device, not shown. The rivet section 28 is thereby pushed onto the reshaping surface 38 and is bent outwardly by it until the state shown in FIG. 8C has been reached. The unit 10a is then reliably fastened to the workpiece 42.

FIG. 9A shows a structural unit 10b that is similar to the structural unit 10. However, deviating from this, a throughgoing bore 24a is provided. The element 14 of the unit 10b also projects into a hole 44a in the workpiece section 46 that is prefabricated or has been punched out by the element 14. The axial support of the element 14 in the fastening process, which results in the relative movement of the elements 12, 14, here takes place by a support shoulder 52 and/or a ring-shaped support surface 54 at the end of the reshaping element 14 remote from the element 12. The surface 54 can be supported at an external support surface (not shown) in the fastening process.

While the reshaping element 14 in accordance with FIG. 9A has an internal thread 26 that enables a screwing in of further components from both sides of the workpiece 42, the reshaping element 14 in accordance with FIG. 9B is a sleeve without an internal thread. Further components can thereby be easily pushed through the bore 24A.

It is generally conceivable that, instead of the rivet element 12 shown, a rivet element is used as is described with reference to FIGS. 6 to 8C.

FIG. 10 shows a fastening unit 10d in a sectional view (above the longitudinal axis A) or in a side view (below the axis A). The fastening unit 10d comprises a rivet element 12 and a reshaping element 14 that are plugged into or pressed into one another to couple the two elements 12, 14 to one another.

Deviating from the embodiments 10, 10b and 10c described above, the rivet element 12 of the unit 10d is closed at one side and forms a kind of cover that closes a central, throughgoing bore 24A in the reshaping element 14 at one side. The bore 24a is sectionally provided with an internal thread 26.

The cover-like character of the rivet element 12 can be easily seen from FIGS. 11A and 11B. It is provided with axial ribs 30.

The reshaping element 14 of the unit 10d is shown in perspective views in FIGS. 12A and 12B. A support surface 20 of the element 14 is designed in ring shape. Ribs 30a providing security against rotation that run in the radial direction extend from said support surface 20 in the axial direction.

A pre-assembled state of the elements 12, 14 or of the unit 10d is shown in FIGS. 13A and 13B. Unlike what is shown, the elements 12, 14—as well as those of the units 10 to 10c—can be connected to one another in one piece. Suitably formed and arranged weakness zones or desired breaking points between the elements 12, 14 permit their relative axial displacement in the fastening process.

This process is shown in FIGS. 14A and 14C. It substantially takes place like the processes described above. In the embodiment shown, the workpiece 42 to which the unit 10d is fastened is again a hollow section that—viewed in the introduction direction—has a prefabricated hole 44 and a smaller prefabricated hole 44a. The diameter of the hole 44a substantially corresponds to the inner diameter of the bore 24a, while the diameter of the hole 44 substantially corresponds to the outer diameter of the cylindrical body of the reshaping element 14. The element can thus be introduced without problem into the hole 44 until its support surface 20 is supported at a ring region around the hole 44a. In this respect, the ribs 30a “dig” into the inner wall of the hollow section 42 there and thus develop an effect that provides security against rotation.

From the moment at which the reshaping element 14 is supported at the hollow section 42, the introduction movement results in a relative movement of the elements 12, 14 that—as already described—leads to a reshaping of the rivet section 12.

Similarly to the unit 10, the fastened unit 10d now acts as a blind bore which is closed at one side, which has an internal thread 26, and to which another component can be fastened. However, the opening of the bore lies on the other side of the hollow section 42 than in the component assembly shown in FIG. 5C.

The support-side end of the unit 10d can also be designed as shown in FIG. 9A or 9B.

The described fastening units 10 to 10d have in common that they can be introduced into and fastened to the workpiece by means of a single introduction movement. Two-stage or multi-stage fastening processes having opposed movement components are considerably more complex.

### REFERENCE NUMERAL LIST

10, 10a,

10b, 10c

10d fastening unit

12 rivet element

14 reshaping element

16 reshaping section

18, 30, 30a rib providing security against rotation

20 support surface

22 elevated portion

24, 24a bore

26 internal thread

28 rivet section

32 collar

34 chamfer

36 pressure surface

38 reshaping surface

40 coupling section

42 workpiece

44, 44a hole

46 workpiece section

48 bolt section

50 external thread

52 support shoulder

54 support surface

1. A fastening unit for fastening to a workpiece, said fastening unit comprising a rivet element and a reshaping element coupled to the rivet element and movable relative thereto, wherein the rivet element has a rivet section and the reshaping element has a reshaping section and a support section, the support section being arranged at a region of the reshaping element remote from the reshaping section, for axially supporting the fastening unit at an abutment, wherein the rivet section and the reshaping section are designed such that, on an axial relative movement between the rivet element and the reshaping element, the rivet section cooperates with the reshaping section and can be reshaped by it in a radial direction.

2. The fastening unit in accordance with claim 1, wherein the rivet element and the reshaping element are separate components.

3. The fastening unit in accordance with claim 1, wherein the rivet element and the reshaping element are coupled to one another by means of the rivet section and the reshaping section.

4. The fastening unit in accordance with claim 1, wherein the rivet element and the reshaping element are formed in one piece.

5. The fastening unit in accordance with claim 1, wherein at least one of the rivet section and the reshaping section is designed in ring shape.

6. The fastening unit in accordance with claim 1, wherein the reshaping element comprises an outer contour that does not project over an outer contour of the rivet section in the radial direction.

7. The fastening unit in accordance with claim 1, wherein the reshaping section has a reshaping surface that diverges away from the rivet section in an axial direction.

8. The fastening unit in accordance with claim 7, wherein the reshaping surface adjoins a coupling section in the axial direction, viewed from the rivet element, said coupling section being provided for coupling the reshaping section to the rivet section.

9. The fastening unit in accordance with claim 1, wherein the rivet element and the reshaping element are coaxially arranged.

10. The fastening unit in accordance with claim 1, wherein, in a region of the rivet element remote from the rivet section, the rivet element has a flange section configured for contact with at least one of the workpiece and a section widened radially relative to the rivet section.

11. The fastening unit in accordance with claim 1, wherein the fastening unit is self-punching.

12. The fastening unit in accordance with claim 1, wherein the support section has a support surface that comprises at least one of an elevated portion and a cut-out.

13. The fastening unit in accordance with claim 1, wherein at least one of the rivet element and the reshaping element has a throughgoing axial opening.

14. The fastening unit in accordance with claim 1, wherein the rivet element is closed at one side in the axial direction.

15. The fastening unit in accordance with claim 1, wherein at least one of the rivet element and the reshaping element has a functional section having an internal thread and an external thread.

16. The fastening unit in accordance with claim 1, wherein at least one of the rivet section, the reshaping section and—if present—the support section has at least one feature providing security against rotation.

17. A component assembly comprising a workpiece and a fastening unit fastened to the workpiece, said fastening unit comprising a rivet element and a reshaping element coupled to the rivet element and movable relative thereto, wherein the rivet element has a rivet section and the reshaping element has a reshaping section and a support section, the support section being arranged at a region of the reshaping element remote from the reshaping section for axially supporting the fastening unit at an abutment, wherein the rivet section and the reshaping section are designed such that, on an axial relative movement between the rivet element and the reshaping element, the rivet section cooperates with the reshaping section and can be reshaped by it in a radial direction, wherein the reshaping section of the rivet section at least sectionally engages behind the workpiece at a side remote from an introduction side from which the fastening unit is introduced into the workpiece.

18. The component assembly in accordance with claim 17, wherein the reshaping element is supported in the axial direction at the workpiece.

19. The component assembly in accordance with claim 18, wherein the reshaping element extends through a hollow space of the workpiece.

20. The component assembly in accordance with claim 19, wherein the workpiece is a hollow section.

21. The component assembly in accordance with claim 17, wherein the workpiece has a prefabricated opening for receiving the fastening unit.

22. The component assembly in accordance with claim 17, wherein a slug punched out of the workpiece by the fastening unit is clamped between the fastening unit and the workpiece.

23. The component assembly in accordance with claim 17, wherein the abutment is formed at the workpiece.

24. A method of manufacturing a component assembly, the component assembly comprising a workpiece and a fastening unit fastened to the workpiece, said fastening unit comprising a rivet element and a reshaping element coupled to the rivet element and movable relative thereto, wherein the rivet element has a rivet section and the reshaping element has a reshaping section and a support section, the support section being arranged at a region of the reshaping element remote from the reshaping section for axially supporting the fastening unit at an abutment, wherein the rivet section and the reshaping section are designed such that, on an axial relative movement between the rivet element and the reshaping element, the rivet section cooperates with the reshaping section and can be reshaped by it in a radial direction, wherein the reshaping section of the rivet section at least sectionally engages behind the workpiece at a side remote from an introduction side from which the fastening unit is introduced into the workpiece in accordance with at least one of the claims 17 to 23, the method comprising the steps:
providing one of a pre-punched and a non-pre-punched workpiece;
providing the fastening unit; and
introducing the fastening unit into the workpiece such that the support section cooperates with the abutment to bring about a relative movement between the rivet element and the reshaping element and thus a reshaping of the rivet section in a radial direction.

25. The method in accordance with claim 24, wherein the fastening unit is introduced into the workpiece and is fixed thereto by means of a single-step axial introduction movement.

26. The method in accordance with claim 24, wherein the introduction of the fastening unit into the workpiece and the fixing of the fastening unit to the workpiece are produced by movement components of the same direction.
